(19) United States
(12) Patent Application Publication
(10) Pub. No.: US 2008/0048848 A1
(43) Pub. Date: Feb. 28, 2008

(54) Image Composing Device and Image Composing Method

(76) Inventor: Satoshi Kawakami, Kanagawa (JP)

Correspondence Address: MCDERMOTT WILL & EMERY LLP, 600 13TH STREET, NW, WASHINGTON, DC, 20005-3096, US

(21) Appl. No.: 11/791,972

(22) PCT Filed: Jun. 30, 2006
(86) PCT No.: PCT/JP06/13138

§ 371 Date: May 31, 2007

(30) Foreign Application Priority Data
Jul. 15, 2005 (JP) 2005-207044

(51) Int. Cl. B60Q 1/00

(52) U.S. Cl. 340/435

(57) ABSTRACT

An object of this invention is to provide an image composing device and image composing method which can exactly display a composed image even if a virtual viewpoint is dynamically changed.

A coordinate conversion table indicative of the correlation between an input image and a distortion-corrected image and the parameter on a virtual viewpoint position necessary to create a composed image are prepared; on the basis of the coordinate conversion table and the parameter on the virtual viewpoint point, virtual viewpoint conversion data indicative of the correlation between the input image and the virtual viewpoint are created; write of camera images for a frame memory (15) is executed and also read of the camera images based on the virtual viewpoint conversion data is executed using the remaining accessed band in the frame memory (15), thereby to create the composed image; and if no camera image can be read out owing to shortage in the accessed band in said frame memory (15), the camera image which could not read out from the frame memory (15) is replaced by any bit map data.

### TECHNICAL FIELD

This invention relates to an image composing device for displaying a processed image of a camera installed on a vehicle in order to reduce a blind spot of the vehicle from a driver and facilitate a driving operation.

### BACKGROUND ART

Traditionally, as the image composing device for composing the respective images acquired from a plurality of cameras installed on the periphery of the vehicle, an image composing device has been proposed in which for example, images seen from above around a driver's own vehicle are deformed and composed and the composed image is displayed on a display device within the vehicle (for example, see Patent Reference 1). Another image composing device has been also proposed in which the position of a virtual viewpoint is dynamically changed in deformation/composition of the images to provide an optimum viewpoint image (composed image) according to a driving situation (for example, Patent Reference 2).

FIG. 3 is a block diagram of the schematic configuration of a vehicle peripheral monitoring device disclosed in Patent Reference 2. The vehicle peripheral monitoring device shown in this figure includes a camera unit 101, an analog/digital (A/D) conversion unit 102, a frame memory unit 103, an image composing unit 104, a digital/analog (D/A) conversion unit 105, a display 106, a conversion table 107 and a viewpoint changing use parameter supplying unit 108. The camera unit 101 includes a plurality of cameras C1 to Cn. The analog/digital conversion unit 102 and frame memory 103 also include analog/digital converters AD1 to ADn and frame memories FM1 to FMn, respectively, whose number is equal to that of the cameras C1 to Cn.

The images picked up by the cameras C1 to Cn are stored in the frame memories FM1 to FMn, respectively. The conversion table 107 is a ROM of a geometric conversion table for distortion correction. The viewpoint changing use parameter supplying unit 108 supplies a viewpoint changing use parameter to the image composing unit 104 in order to dynamically change the viewpoint changing. The image composing device 104 is constructed of a CPU or DSP (Digital Signal Processor). The image composing device 104 corrects the distortion of the images acquired from the cameras C1 to Cn on the basis of the geometric conversion table in the conversion table 107 and makes address computation for conversion on the basis of the viewpoint conversion parameter supplied from the viewpoint conversion parameter supplying unit 108.

In this way, the conversion table for distortion correction which is invariable for the viewpoint position is previously computed to make the ROM. For the viewpoint conversion/composition whose conversion rule is changed according to a starting point, the address computation for conversion is sequentially made on the basis of the parameter supplied from the viewpoint conversion use parameter supplying unit 108. Thus, by dynamically changing the viewpoint position, an optimum composed image can be displayed on the display 106 installed within the vehicle according to the driving situation.

Patent Reference 1: JP-A-58(Showa)-110334

Patent Reference 2: JP-A-2001-339716

### DISCLOSURE OF THE INVENTION

<Problems that the Invention is to Solve>

Meanwhile, considering the image quality of the composed image, by interpolating/creating the composed image with the correspondence between an composed image and an input image being not 1 pixel to 1 pixel but 1 pixel to plural pixels, the image quality can be improved. In this case, if the input image is considered two-dimensionally, in order to acquire one pixel of the composed image, two pixels in each of X-direction and Y-direction, i.e. four pixels in total are required. Correspondingly, the quantity of access to the frame memory increases. Since the accessed band in the frame memory influences the production cost, it is important how the image quality is improved in the limited accessed band. Concretely, there are a technique of limiting improvement of the image quality to a specific portion of the composed image and another technique of reading out the one pixel without interpolating if the interpolating ratio is high. In both techniques, however, the quantity of access to the entire frame memory changes according to the position of the virtual viewpoint.

However, in the conventional image composing device, increase or decrease in the quantity of memory access to the frame memory due to dynamic changing of the virtual viewpoint is not considered. Therefore, owing to failure in the read-out of the image data attributable to shortage in the accessed band in the frame memory, the image may be lost. Further, if a line memory is loaded, the image read out at the time of previous line is disadvantageously displayed. Incidentally, in the case of the NTSC (National Television Standards Committee) system, since the time axis in interlace differs in an even line and an odd line, for example, even if two lines of the odd line are outputted in the same image, a different image corresponding to the odd line therebetween resides so that the resultant image becomes unnatural.

This invention has been accomplished in view of the above circumstances. An object of this invention is to provide an image composing device and image composing method which can exactly display a composed image even if a virtual viewpoint is dynamically changed.

Means for Solving the Problems

The above object can be achieved by the following arrangements and methods.
(1) An image composing device comprises: a coordinate conversion table storing unit for storing a coordinate conversion table indicative of the correlation between an input image and a distortion-corrected image; a virtual viewpoint conversion data creating unit for creating virtual viewpoint conversion data indicative of the correlation between the input image and the composed image seen from the virtual viewpoint on the basis of the coordinate conversion table stored in the coordinate conversion table storing means and the parameter on a virtual viewpoint position; a viewpoint conversion use parameter supplying means for supplying, to the virtual viewpoint conversion data creating means, the parameter on the virtual viewpoint position necessary to create a composed image; a memory controlling means for executing write of the camera images for a frame memory and also executing read of the camera images based on the virtual viewpoint conversion data created by the virtual viewpoint conversion data creating means using the remaining accessed band in the frame memory, thereby creating the composed image and for producing the information indicative of failure of the read if no camera image can be read out owing to shortage in the accessed band in the frame memory; and a virtual viewpoint image converting means for replacing, if the information indicative of failure of the read of any camera image is outputted from the memory control means, the camera image which could not be read out by the memory controlling means owing to shortage in the accessed band in the frame memory by another image data.
(2) In the image composing device defined the above item (1), the virtual viewpoint image converting means creates the composed image without using the camera image which could not be read by the memory control means.
(3) In the image composing device defined in the above item (1), where a single composite pixel composed from plural pixels is created, even if a part of the plural pixels cannot be read from the memory control means owing to shortage of an accessed band in the frame memory the virtual viewpoint image converting means creates the composed image using remaining pixels.
(4) An image composing device comprises: a coordinate conversion table storing unit for storing a coordinate conversion table indicative of the correlation between an input image and a distortion-corrected image; a virtual viewpoint conversion data creating unit for creating virtual viewpoint conversion data indicative of the correlation between the input image and the composed image seen from the virtual viewpoint on the basis of the coordinate conversion table stored in the coordinate conversion table storing means and the parameter on a virtual viewpoint position; a viewpoint conversion use parameter supplying means for supplying, to the virtual viewpoint conversion data creating means, the parameter on the virtual viewpoint position necessary to create a composed image; a frame-memory accessed-band computing means for computing the quantity of memory access to a frame memory on the basis of the number of input camera images and the virtual viewpoint conversion data created by the virtual viewpoint conversion data creating means; a memory access data controlling means for controlling the quantity of memory access data of the virtual viewpoint conversion data on the basis of the quantity of memory access computed by the frame-memory accessed-band computing means; and a memory controlling unit for executing write of the camera images for the frame memory and also executing the read of the camera images based on the virtual viewpoint conversion data whose quantity of memory access data is controlled by the memory access data controlling means using the remaining accessed band in the frame memory, thereby creating the composed image.
(5) An image composing method comprises the steps of: preparing a coordinate conversion table indicative of the correlation between an input image and a distortion-corrected image and the parameter on a virtual viewpoint position necessary to create a composed image; creating, on the basis of the coordinate conversion table and the parameter on the virtual viewpoint point, virtual viewpoint conversion data indicative of the correlation between the input image and the virtual viewpoint; executing write of camera images for a frame memory and also executing read of the camera images based on the virtual viewpoint conversion data using the remaining accessed band in the frame memory, thereby to create the composed image; and replacing, if no camera image can be read out owing to shortage in the accessed band in the frame memory, the camera image which could not read out from the frame memory by another image data thereby to create the composed image.
(6) In the image composing method defined in the above item (5), the composed image is created without using the camera image which could not be read owing to shortage in the accessed band in the frame memory.
(7) In the image composing device defined in the above item (5), where a single composite pixel composed from plural pixels is created, even if a part of the plural pixels cannot be read from the memory control means owing to shortage of an accessed band in the frame memory, the composed image is created using remaining pixels.
(8) An image composing method comprises the steps: preparing a coordinate conversion table indicative of the correlation between an input image and a distortion-corrected image and the parameter on a virtual viewpoint position necessary to create a composed image; creating, on the basis of the coordinate conversion table and the parameter on the virtual viewpoint point, virtual viewpoint conversion data indicative of the correlation between the input image and the virtual viewpoint; computing the quantity of memory access to the frame memory on the basis of the virtual viewpoint conversion data thus created and the number of input camera images; controlling the quantity of memory access data of the virtual viewpoint conversion data on the basis of the quantity of memory access thus computed; and executing write of the camera images for the frame memory and also executing read of the camera images based on the virtual viewpoint conversion data whose quantity of memory access data is controlled, using the remaining accessed band in the frame memory, thereby creating the composed image.

### Advantage of the Invention

In the image composing device defined in the above item (1), the camera image which could not be read out by said memory controlling means owing to shortage in the accessed band in the frame memory is replaced by another image data (e.g. specific image data such as bit map data) thereby to create the composed image. For this reason, even if the virtual viewpoint is dynamically changed, the image will not be lost and the image read out at the time of the previous line will not be displayed, thereby permitting the exact composed image to be always displayed.

In the image composing device defined in the above item (2), if at least one camera image can be read out from the frame memory, without being replaced by another image data (specific image data such as bitmap data, the composed image of the actual camera images can be acquired.

In the image composing device defined in the above item (3), where a single composite pixel composed from plural pixels is created, if at least one camera image can be read out from the frame memory, without being replaced by another image data (specific image data such as bit map data, the composed image of the actual camera images can be acquired.

In the image composing device defined in the above item (4), since the quantity of memory access data of the virtual viewpoint conversion data is controlled within the range not exceeding the accessed band in the frame memory, the processing of replacing the camera image which could not be read out by another image data can be omitted.

In the image composing method defined in the above item (5), the camera image which could not be read out by said memory controlling means owing to shortage in the accessed band in the frame memory by another data (e.g. specific image data such as bit map data) thereby to create the composed image. For this reason, even if the virtual viewpoint is dynamically changed, the image will not be lost and the image read out at the time of the previous line will not be displayed, thereby permitting the exact composed image to be always displayed.

In the image composing method defined in the above item (6), if at least one camera image can be read out from the frame memory, without being replaced by another image data (specific image data such as bit map data, the composed image of the actual camera images can be acquired.

In the image composing method defined in the above item (7), where a single composite pixel composed from plural pixels is created, if at least one camera image can be read out from the frame memory, without being replaced by another image data (specific image data such as bit map data, the composed image of the actual camera images can be acquired.

In the image composing device defined in the above item (8), since the quantity of memory access data of the virtual viewpoint conversion data is controlled within the range not exceeding the accessed band in the frame memory, the processing of replacing the camera image which could not be read out by another image data can be omitted.

### BRIEF DESCRIPTION OF THE DRAWINGS

FIG. 1 is a block diagram showing the schematic arrangement of an image composing device according to the first embodiment of this invention.

FIG. 2 is a block diagram showing the schematic arrangement of an image composing device according to the second embodiment of this invention.

FIG. 3 is a block diagram of the schematic arrangement of a conventional image composing device.

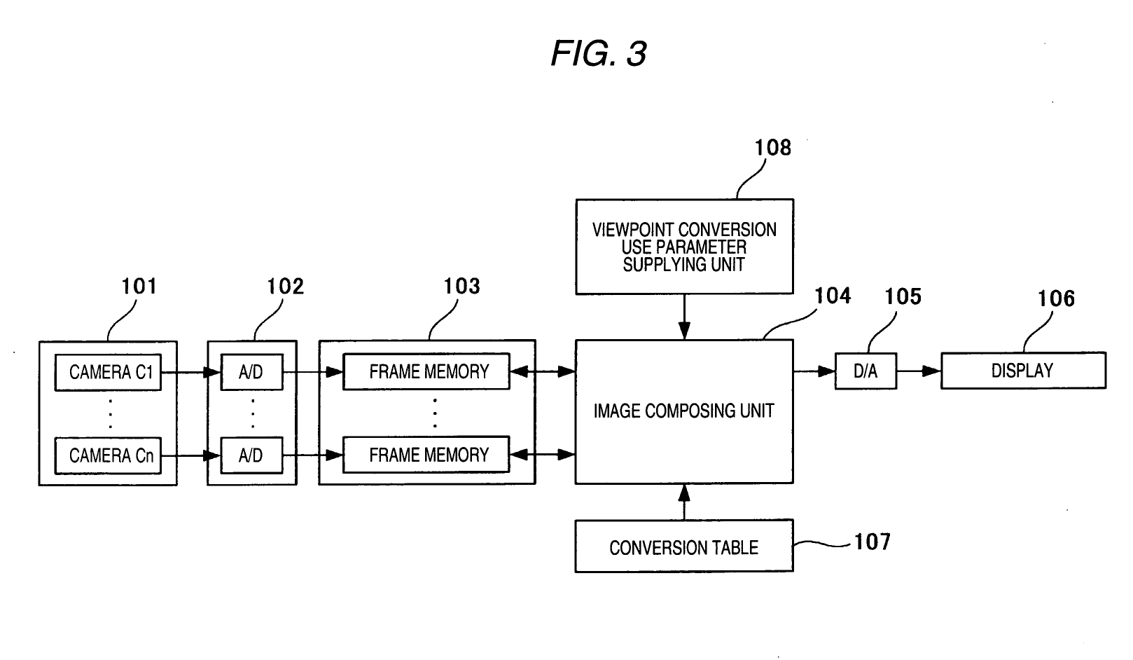

### DESCRIPTION OF REFERENCE NUMERALS AND SIGNS

10 camera unit
11 coordinate conversion table storing unit
12 virtual viewpoint conversion data creating unit
13 viewpoint conversion use parameter supplying unit
14 memory controlling unit
15 frame memory
16 virtual viewpoint image converting unit
18 frame-memory accessed-band computing unit
19 memory access data controlling unit

### BEST MODE FOR CARRYING OUT THE INVENTION

Now referring to the drawings, a detailed explanation will be given of preferable embodiments of this invention.

### Embodiment 1

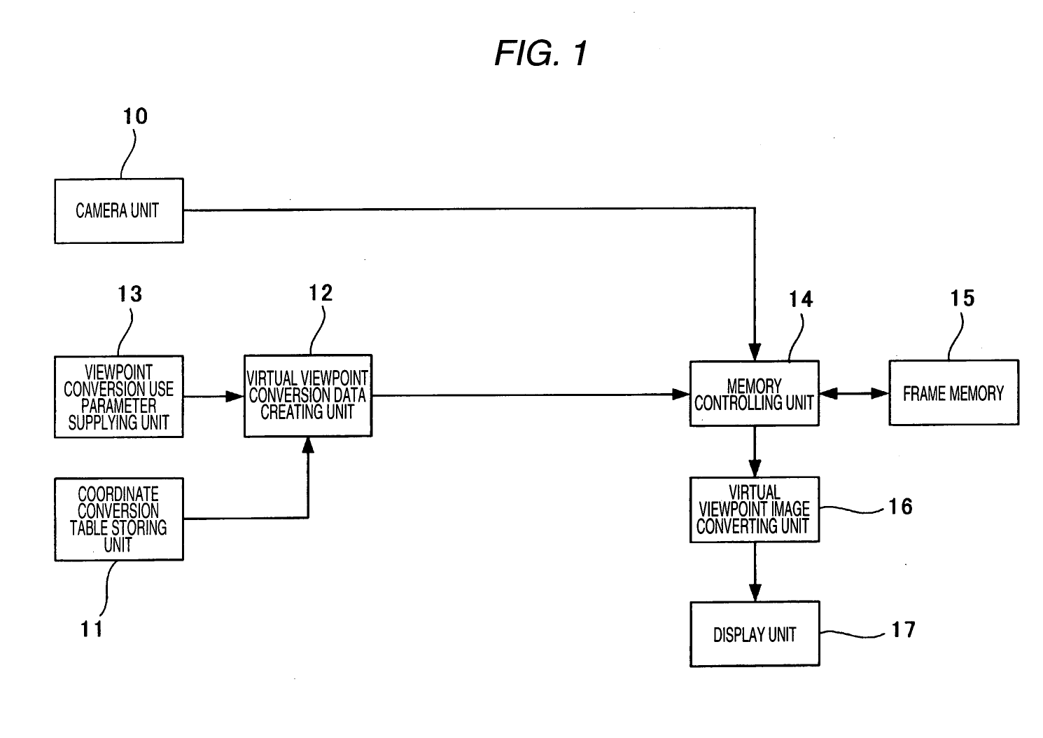

FIG. 1 is a block diagram showing the schematic arrangement of an image composing device according to the first embodiment of this invention. In this figure, the image composing device according to this embodiment includes a camera unit 10, a coordinate conversion table storing unit 11, a virtual viewpoint conversion data creating unit 12, a viewpoint conversion use parameter supplying unit 13, a memory controlling unit 14, a frame memory 15, a virtual viewpoint image converting unit 16 and a display unit 17.

The camera unit 10 is constructed of a plurality of cameras (not shown) like before, and is used for picking up an object. The coordinate conversion table storing unit 11 stores a coordinate conversion table indicative of the correlation between an input image and a distortion-corrected image, i.e. the relationship between the image coordinates after conversion and the image coordinates before conversion. The virtual viewpoint conversion data creating unit 12 sequentially computes the correlation between the distortion-corrected image and the composed image thereby to create the virtual viewpoint conversion data for acquiring the image seen from the virtual viewpoint. The viewpoint conversion use parameter supplying unit 13 supplies, to the virtual viewpoint conversion data creating unit 12, the parameter on the virtual viewpoint position necessary to create the composed image. The frame memory 15 stores camera images.

The memory controlling unit 14 executes write and read of the camera images for the frame memory 15 to create the composed image. The virtual viewpoint image converting unit 16 replaces the camera image which could not be read out by the memory controlling unit 14 owing to shortage in the accessed band in the frame memory 15 by another image data such as a bit map data. In this case, if at least one camera image can be read out from the frame memory 15, without being replaced by another image data such as the bit map data, the composed image of the actual camera images can be acquired. The display unit 17 visually displays the composed image produced from the virtual viewpoint image converting unit 16.

Next, an explanation will be given of the operation of the image composing device having the arrangement described above. In the virtual viewpoint conversion data creating unit 12, the virtual viewpoint conversion data indicative of the correlation between the composed image seen from the virtual viewpoint and the input image are created on the basis of the coordinate conversion table stored in the coordinate conversion table storing unit 11 and the parameter on the virtual viewpoint position supplied from the viewpoint conversion use parameter supplying unit 13. The contents of the virtual viewpoint conversion data are the XY coordinates (Xi, Yi) of the input image corresponding to the XY coordinates (Xo, Yo) of the composed image, and an X-axis interpolating coefficient Xk and an Y-axis interpolating coefficient Yk.
(Xo, Yo)=Xk×{Yk×(Xi,Yi)+(1−Yk)×(Xi,Yi+1)}+(1−Xk)×{Yk×(Xi+1,Yi)+(1−Yk)×(Xi+1, Yi+1)} (1)

In this case, the one pixel of the composed image is acquired from four pixels of the input image of (Xi,Yi), (Xi,Yi+1), (Xi+1,Yi) and (Xi+1, Yi+1). However, considering the case where Xk=1 or Yk=1, the number of the pixels actually required changes in a range from one to four pixels according to the value of the interpolating coefficient.

The memory controlling unit 14 executes write of the camera images for the frame memory 15 and also executes read of the camera images based on the virtual viewpoint conversion data created by the virtual viewpoint conversion data creating unit 12 using the remaining accessed band in the frame memory 15, thereby creating the composed image. If no camera image can be read out owing to shortage in the accessed band in the frame memory 15, the memory controlling unit 14 produces the information indicative of failure of the read. In this case, where no camera image can be read out owing to shortage in the accessed band in the frame memory 15, the memory controlling unit 14 notifies the virtual viewpoint image converting unit 16 of the failure of the read. In the virtual viewpoint image converting unit 16, the composed image is computed using the above Equation (1) on the basis of the camera image read from the frame memory 15. The composed image is displayed on the display unit 17. In this case, if the read of any camera image has ended in failure, the composed image is replaced by any bit map data.

As described above, in the image composing device according to this embodiment, the coordinate conversion table indicative of the correlation between the input image and the distortion-corrected image and the parameter on the virtual viewpoint position necessary to create the composed image are prepared; on the basis of the coordinate conversion table and the parameter on the virtual viewpoint point, the virtual viewpoint conversion data indicative of the correlation between the input image and the virtual viewpoint are created; the write of the camera images is executed for the frame memory 15 and also using the remaining accessed band in the frame memory 15, the read of the camera images based on the virtual viewpoint conversion data is executed thereby to create the composed image; and if no camera image can be read out owing to shortage in the accessed band in the frame memory 15, the camera image which could not be read out from the frame memory 15 is replaced by any bit map data. For this reason, even if the virtual viewpoint is dynamically changed so that the quantity of access of the memory controlling unit 14 to the frame memory 15 exceeds the accessed band, the image will not be lost and the image read out at the time of the previous line will not be displayed, thereby permitting the exact composed image to be always displayed.

Where the image composing device according to this embodiment is employed in the vehicle peripheral monitoring device, it is possible to reduce the blind spot from the vehicle driver and facilitate the driving operation.

Incidentally, in this embodiment, in the virtual viewpoint image converting unit 16, if the read of the camera image has only ended in failure, the pertinent composed image is replaced by any bit map data. However, where a plurality of camera image data are required in order to compute the composed image, if the read of at least one camera image data has succeeded, the composed image may be acquired using this camera image data.

### Embodiment 2

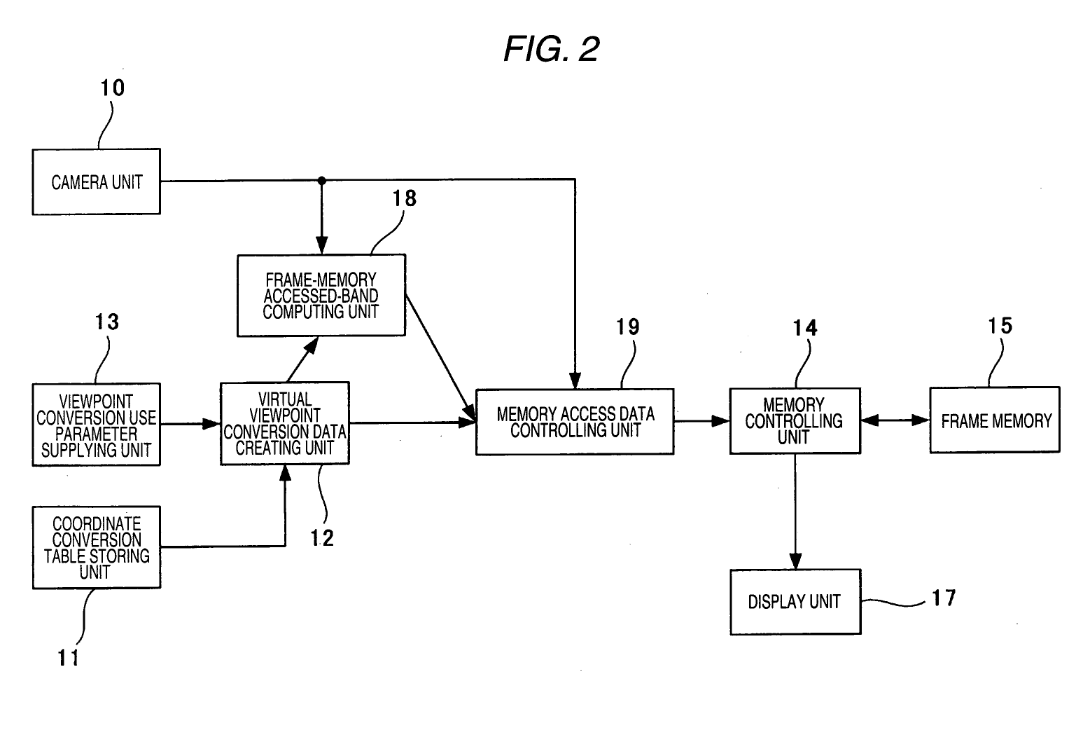

FIG. 2 is a block diagram showing the schematic arrangement of an image composing device according to the second embodiment of this invention. In this figure, like reference numerals refer to like constituent elements in FIG. 1. In FIG. 2, the image composing device according to this embodiment includes a camera unit 10; a coordinate conversion table storing unit 11; a virtual viewpoint conversion data creating unit 12; a viewpoint conversion use parameter supplying unit 13; a frame memory 15; a frame-memory accessed-band computing unit 18 for computing the quantity of memory access to the frame memory 15 on the basis of the number of input camera images and the virtual viewpoint conversion data created by the virtual viewpoint conversion data creating unit 12, a memory access data controlling unit 19 for controlling the quantity of access to the frame memory 15 by controlling, if the quantity of access to the frame memory 15 computed by the frame-memory accessed-band computing unit 18 exceeds the accessed band in the frame memory 15, the interpolating coefficient of the virtual viewpoint conversion data thereby to approximate Xk or Yk to 1; a memory controlling unit 14 for executing write of the camera images for the frame memory 15 and also executing the read of the camera images based on the virtual viewpoint conversion data whose quantity of memory access data is controlled by the memory access data controlling unit 19 using the remaining accessed band in the frame memory 15, thereby creating the composed image; and a display unit 17 for visually displaying the composed image created by the memory controlling unit 14.

Next, an explanation will be given of the operation of the image composing device having the arrangement described above. In the virtual viewpoint conversion data creating unit 12, the virtual viewpoint conversion data indicative of the correlation between the composed image seen from the virtual viewpoint and the input image are created on the basis of the coordinate conversion table supplied from the coordinate conversion table storing unit 11 and the parameter on the virtual viewpoint position supplied from the viewpoint conversion use parameter supplying unit 13. The contents of the virtual viewpoint conversion data, as in the first embodiment described above, are the XY coordinates (Xi, Yi) of the input image corresponding to the XY coordinates (Xo, Yo) of the composed image, and an X-axis interpolating coefficient Xk and an Y-axis interpolating coefficient Yk. The frame-memory accessed-band computing unit 18 computes the quantity of access necessary for access to the frame memory 15 on the basis of the camera image and the virtual viewpoint conversion data. If the quantity of access exceeds the accessed band, in the memory access data controlling unit 19, the X-axis interpolating coefficient and the Y-axis interpolating coefficient are approximated to “1” in the order of the value near to “1”, thereby controlling the quantity of access. While the quantity of access becomes lower than the accessed band, the control is completed. In the memory controlling unit 14, the write and read of the camera image for the frame memory 15 are executed so that the composed image is created on the basis of the camera thus read. The composed image is displayed on the display unit 17.

As described above, in the image composing device according to this embodiment, the coordinate conversion table indicative of the correlation between the input image and the distortion-corrected image and the parameter on the virtual viewpoint position necessary to create the composed image are prepared; on the basis of the coordinate conversion table and the parameter on the virtual viewpoint point, the virtual viewpoint conversion data indicative of the correlation between the input image and the virtual viewpoint are created; the quantity of memory access to the frame memory 15 is computed on the basis of the virtual viewpoint conversion data thus created and the number of input camera images; the quantity of memory access data of the virtual viewpoint conversion data is controlled on the basis of the quantity of memory access computed; and the write of the camera images is executed for the frame memory 15 and also using the remaining accessed band in the frame memory 15, the read of the camera images based on the virtual viewpoint conversion data whose quantity of memory access data is controlled is executed. For this reason, even if the virtual viewpoint is dynamically changed so that the quantity of access of the memory controlling unit 14 to the frame memory 15 exceeds the accessed band, the image will not be lost and the image read out at the time of the previous line will not be displayed, thereby permitting the exact composed image not confusing the driver to be always displayed. Particularly, in this embodiment, since the quantity of memory access data of the virtual viewpoint conversion data is controlled within the range not exceeding the accessed band of the frame memory 15, the processing of replacing the camera image which could not be read out by another image data can be omitted.

Where the image composing device according to this embodiment is also employed in the vehicle peripheral monitoring device, it is possible to reduce the blind spot from the vehicle driver and facilitate the driving operation.

This invention has been explained in detail and referring to the specific embodiment. However, it is apparent to those skilled in the art that this invention can be changed or modified in various manners without departing from the spirit and scope of the invention.

This application is based on Japanese Patent Application (Patent Application No. 2005-207044) filed on Jul. 15, 2005, and the contents thereof are incorporated herein by reference.

### INDUSTRIAL APPLICABILITY

This invention gives an effect that even if the virtual viewpoint is dynamically changed, the image will not be lost and the image read out at the time of the previous line will not be displayed, thereby permitting the exact composed image to be always displayed. This invention, therefore, can be applied to a vehicle peripheral monitoring device for displaying a processed image of a camera installed on a vehicle.

1. An image composing device comprising:
a coordinate conversion table storing unit for storing a coordinate conversion table indicative of the correlation between an input image and a distortion-corrected image;
a virtual viewpoint conversion data creating unit for creating virtual viewpoint conversion data indicative of the correlation between the input image and the composed image seen from the virtual viewpoint on the basis of the coordinate conversion table stored in said coordinate conversion table storing means and the parameter on a virtual viewpoint position;
a viewpoint conversion use parameter supplying means for supplying, to said virtual viewpoint conversion data creating means, the parameter on said virtual viewpoint position necessary to create a composed image;
a memory controlling means for executing write of the camera images for a frame memory and also executing read of the camera images based on the virtual viewpoint conversion data created by the virtual viewpoint conversion data creating means using the remaining accessed band in said frame memory, thereby creating the composed image and for producing the information indicative of failure of the read if no camera image can be read out owing to shortage in the accessed band in said frame memory; and
a virtual viewpoint image converting means for replacing, if the information indicative of failure of the read of any camera image is outputted from said memory control means, the camera image which could not be read out by said memory controlling means owing to shortage in the accessed band in the frame memory by another image data.

2. The image composing device according to claim 1, wherein said virtual viewpoint image converting means creates the composed image without using the camera image which could not be read by said memory control means.

3. The image composing device according to claim 1, wherein where a single composite pixel composed from plural pixels is created, even if a part of the plural pixels cannot be read from said memory control means owing to shortage of an accessed band in said frame memory said virtual viewpoint image converting means creates the composed image using remaining pixels.

4. An image composing device comprising:
a coordinate conversion table storing unit for storing a coordinate conversion table indicative of the correlation between an input image and a distortion-corrected image;
a virtual viewpoint conversion data creating unit for creating virtual viewpoint conversion data indicative of the correlation between the input image and the composed image seen from the virtual viewpoint on the basis of the coordinate conversion table stored in said coordinate conversion table storing means and the parameter on a virtual viewpoint position;
a viewpoint conversion use parameter supplying means for supplying, to said virtual viewpoint conversion data creating means, the parameter on said virtual viewpoint position necessary to create a composed image;
a frame-memory accessed-band computing means for computing the quantity of memory access to a frame memory on the basis of the number of input camera images and the virtual viewpoint conversion data created by said virtual viewpoint conversion data creating means;
a memory access data controlling means for controlling the quantity of memory access data of said virtual viewpoint conversion data on the basis of the quantity of memory access computed by said frame-memory accessed-band computing means; and
a memory controlling unit for executing write of the camera images for said frame memory and also executing the read of the camera images based on the virtual viewpoint conversion data whose quantity of memory access data is controlled by the memory access data controlling means using the remaining accessed band in said frame memory, thereby creating the composed image.

5. An image composing method comprising the steps of:
preparing a coordinate conversion table indicative of the correlation between an input image and a distortion-corrected image and the parameter on a virtual viewpoint position necessary to create a composed image;
creating, on the basis of the coordinate conversion table and the parameter on the virtual viewpoint point, virtual viewpoint conversion data indicative of the correlation between the input image and the virtual viewpoint;
executing write of camera images for a frame memory and also executing read of the camera images based on the virtual viewpoint conversion data using the remaining accessed band in said frame memory, thereby to create the composed image; and
replacing, if no camera image can be read out owing to shortage in the accessed band in said frame memory, the camera image which could not read out from the frame memory by another image data thereby to create the composed image.

6. The image composing method according to claim 5, wherein the composed image is created without using the camera image which could not be read owing to shortage in the accessed band in said frame memory.

7. The image composing device according to claim 5, wherein where a single composite pixel composed from plural pixels is created, even if a part of the plural pixels cannot be read from said memory control means owing to shortage of an accessed band in said frame memory, the composed image is created using remaining pixels.

8. An image composing method comprising the steps:
preparing a coordinate conversion table indicative of the correlation between an input image and a distortion-corrected image and the parameter on a virtual viewpoint position necessary to create a composed image;
creating, on the basis of the coordinate conversion table and the parameter on the virtual viewpoint point, virtual viewpoint conversion data indicative of the correlation between the input image and the virtual viewpoint;
computing the quantity of memory access to the frame memory on the basis of the virtual viewpoint conversion data thus created and the number of input camera images;
controlling the quantity of memory access data of the virtual viewpoint conversion data on the basis of the quantity of memory access thus computed; and
executing write of the camera images for said frame memory and also executing read of the camera images based on the virtual viewpoint conversion data whose quantity of memory access data is controlled, using the remaining accessed band in the frame memory, thereby creating the composed image.
